(19) United States
(12) Patent Application Publication
(10) Pub. No.: US 2015/0375647 A1
(43) Pub. Date: Dec. 31, 2015

(54) VEHICLE SEAT, IN PARTICULAR FOR A MOTOR VEHICLE

(71) Applicant: Faurecia Autositze GmbH, Stadthagen (DE)

(72) Inventor: Meinhard BEHRENS, Wiedensahl (DE)

(21) Appl. No.: 14/824,895

(22) Filed: Aug. 12, 2015

Related U.S. Application Data
(63) Continuation of application No. PCT/DE2014/100023, filed on Jan. 29, 2014.

(30) Foreign Application Priority Data
Feb. 13, 2013 (DE) 10 2013 101 540.9

(51) Int. Cl. B60N 2/427; B60N 2/42; B60N 2/16

(52) U.S. Cl. CPC B60N 2/42763; B60N 2/1615; B60N 2/4221

(57) ABSTRACT

Vehicle seat, in particular, for a motor vehicle, has a seat cushion to accommodate a person, and a support member protecting a person on the seat cushion against sliding beneath a seat belt. There is an adjustment device for adjusting the support member relative to the seat cushion. The adjustment device for adjusting the support member is provided between a default position and an activated position depending on a position of the seat cushion relative to another component. The relative position may be, in particular, a vertical or longitudinal position.

### CROSS-REFERENCE TO RELATED APPLICATIONS

This application is a continuation of application no. PCT/DE2014/100023, filed 29 Jan. 2014, which claims the priority of German Application No. 10 2013 101 540.9, filed 15 Feb. 2013, and each of which is incorporated herein by reference.

### FIELD OF THE INVENTION

The present invention relates to a vehicle seat suitable, in particular, for a vehicle seat for a motor vehicle and provided with a protection device for protecting against sliding beneath a seat belt.

### BACKGROUND OF THE INVENTION

Restraint systems like safety belts mounted on vehicle seats serve, inter alia, to restrain a person sitting in the vehicle seat in the event of a rapid deceleration of the vehicle, in particular, a front crash. Hereby, the seat occupant due to its inertia is accelerated forward in the vehicle seat and caught by the restraint system, e.g. at his/her torso region.

Hereby, generally, the seat occupant, depending on position and seat adjustment, may also be pressed into the cushion elements of the vehicle seat and slide beneath the buckled seat belt or e.g. get caught in a safety belt by his/her head.

In order to prevent such problematic sliding action protection systems against sliding beneath a seat belt or “anti-submarining systems” respectively are known, creating a counter surface for catching the seat occupant. To that end, generally, a support member is provided in the seat cushion, in particular, in or upon the structure of the seat cushion beneath the cushion elements. Hereby, adjustable support members are also known.

The document DE 102 56 100 A1 discloses a vehicle seat with such a protection means against sliding beneath a seat belt. The support member is provided vertically moveably on the seat cushion or a frame of the seat cushion in order to be vertically adjusted upwards on activation thereby moving a soft cushion element disposed on top of it upwards correspondingly. The adjustment of the support member is coupled to an inclination position of the back rest so that the support member is lowered when the back rest pivots forward.

The document FR 2 847 862 A1 describes an adjustment of a structure element of a protection means against sliding beneath a seat belt, the element being coupled to a belt tightener. Thus, the support member may be adjusted depending on the belt adjustment.

### OBJECTS AND SUMMARY OF THE INVENTION

It is an object of the invention to create a further vehicle seat with a protection device for protecting against sliding beneath a seat belt allowing an automatic adjustment of the protection means against sliding beneath a seat belt.

This object is achieved by a vehicle seat according to the invention set forth herein. The specification, including drawings and claims, describes preferred further embodiments.

Generally, the invention is based on the finding that, in particular, with persons of smaller sizes, sliding beneath a seat belt may be problematic. Restraint systems and systems protecting against sliding beneath seat belts are generally designed with persons in mind that have sizes within a certain normal range; thus, for example, the attachments and the path of a safety belt and the position of the protection device against sliding beneath the seat belt are adapted to usual dimensions, e.g. for a normal range covering about 95 percent of the persons to sit in such seats. For smaller persons, however, this adjustment may be problematic with the danger of sliding beneath the seat belt remaining.

Thus, according to the invention, the position of the seat cushion itself is utilised for adjusting the protection device against sliding beneath the seat belt. According to the invention, the adjustment device is thus provided for adjusting the support element depending on a position of the seat cushion. This position of the seat cushion, generally, is primarily a position relative to another component; in particular, it may be a position relative to the upper or lower rail of the vehicle seat or, alternatively, a bearing block of the vehicle seat.

The position or relative position respectively may, in accordance with one embodiment, be a longitudinal position of the longitudinally adjustable vehicle seat, i.e. a longitudinal position of the seat cushion together with the upper rail accommodating the seat cushion in relation to a lower rail to be mounted on or mounted on the vehicle.

This embodiment is based on the thought that persons which require adjustment of the protection device against sliding beneath the seat belt, generally, due to their smaller bodies, tend to select longitudinally forward positions of the longitudinal adjustment device of the vehicle seat in order to operate the pedals, the steering wheel and, if applicable, further operating elements in the dashboard area more easily. Thus, it can be inferred from a longitudinally forward positions of the longitudinal adjustable vehicle seat that in this case the protection device against sliding beneath the seat belt must be adjusted to accommodate for a smaller person.

According to a further embodiment according to the invention the protection device against sliding beneath the seat belt may be adjusted depending on a vertical adjustment of the seat cushion, in particular, on the vertical position of the seat cushion in relation to the upper rail or an attachment on the chassis. Hereby, in particular, the support member may be adjusted to its activated position when the user selects a higher vertical adjustment.

This, in turn, is based on the thought in accordance with the invention that the persons or seat occupants respectively relevant for the protection against sliding beneath the seat belt generally tend to select, due to their smaller body size, a higher seat position, in particular, in order to improve usability of the dashboard area and to allow for better vision through the windshield of the vehicle.

These two adjustment concepts, i.e. based upon the longitudinal position on the one hand and based upon the vertical position on the other, may be provided alternatively or complementarily.

Thus, in particular, the support member may serve already in its non-adjusted or, respectively, non-activated default position as protection device against sliding beneath the seat belt for a person inside a normal range and may be adjusted to an activated position by corresponding adjustment of the seat cushion in which the support member is in a position more adapted to smaller persons, in particular, by device of raising the support member and/or adjusting it backwards towards the back rest.

In the case of activation based on the vertical position the support member may be coupled to the rocker arms hinged between the seat cushion and the lower attachment, i.e. lower rail or bearing attachment, for vertical adjustment. Hereby, in particular, a fixed coupling of the support member to the rocker arms is possible. This is in recognition of the fact that the pivoting motion of the rocker arms during vertical adjustment already allows for an upwards adjustment of a support member in relation to the seat cushion. To that end, the support member is preferably attached between the two lateral front rocker arms extending e.g. as a curved or cranked tube in perpendicular direction. Thus, in this case, the rocker arms may directly serve as adjustment device.

In particular the case of activation based on the longitudinal position the adjustment may happen via a coupling device extending from the rail area to the seat cushion. Thus, the adjustment device as such can be provided in the area of the lower rail and/or the upper rail and activates the adjustment of the support member via the coupling device. Hereby, the adjustment device may be designed mechanical, pneumatical or hydraulical or even electro-mechanical. This, in the case of a pneumatic or hydraulic solution, advantageously, a fluid pipe is made to extend from the rail area upwards to the seat cushion. In the case of the electro-mechanical solution, a wire rope may be made to extend from the rail area upwards to the seat cushion or an electrical line to an electric motor adjusting the support member in the seat cushion.

Such adjustment device may be provided for several adjustments, in particular, both for the support member and for a comfort adjustment like longitudinal or vertical adjustment. Thus, the support member can be adjusted correspondingly by an adjustment device existing anyway via a coupling device.

In the case of a mechanical solution, in particular, a construction using a wire rope, e.g. as a Bowden cable, is advantageous. Hereby, the wire rope may be attached at one end to the support member and at its other end to another component against which the seat cushion is adjusted, e.g. in the case of longitudinal adjustment to the lower rail. Thus, the adjustment motion of the seat cushion can be directly utilised for adjusting the support member in relation to the seat cushion.

Hereby, it is possible to adjust the support member e.g. by means of a ramp provided in the seat cushion adjustably housing the support member, in particular, extending from the front and the bottom towards the back and upwards.

The protection device against sliding beneath the seat belt may be activated e.g. only at one end region of the adjustment, e.g. an upper third of the vertical adjustment and/or a front third of the longitudinal adjustment. One or more activated positions may be provided, i.e. intermediate positions, if applicable, may be provided between the default position and a fully activated position.

Relative terms such as left, right, up, and down are for convenience only and are not intended to be limiting.

### BRIEF DESCRIPTION OF THE DRAWINGS

Subsequently, the invention is illustrated by means of the accompanying drawings in several embodiment examples. Therein is shown as follows:

FIG. 1 a vehicle seat according to a first embodiment with anti-submarining adjustment depending on a longitudinal position, shown in the backward longitudinal position of the vehicle seat;

FIG. 2 a representation corresponding to that of FIG. 1, shown in the forward position of the vehicle seat;

FIG. 3 a vehicle seat according to a further embodiment with anti-submarining adjustment depending on a vertical adjustment, shown in the lower vertical position;

FIG. 4 a representation corresponding to that of FIG. 3, shown in the upper vertical position;

FIG. 5 a vehicle seat according to a further embodiment with anti-submarining adjustment with ramp adjustment depending on the longitudinal position, shown in a backward position;

FIG. 6 a representation corresponding to that of FIG. 5, shown in a forward position; and

FIG. 7 a vehicle seat with anti-submarining adjustment depending on the longitudinal position in a) backward and b) forward longitudinal position, with pneumatic, hydraulic or electro-mechanical adjustment.

### DETAILED DESCRIPTION OF THE INVENTION

A vehicle seat 1 comprises lower rails 2 to be attached to a vehicle bottom, upper rails 3 adjustable on the lower rails 2 in the longitudinal direction x, a seat cushion 4, vertically adjustable in relation to the upper rails 3 by use of a front rocker 5 and a back rocker 6, and a back rest 8, indicated in FIG. 1, hinged inside the seat cushion 4 adjustably in a rest axis A. Between the seat cushion 4 and each of the two upper rails 3—left and right—a front rocker 5 and a back rocker 6 are provided each; generally, in the figures only one side of the vehicle seat 1 is shown.

On the seat cushion 4 a support member 10 for an anti-submarining function is provided in an adjustable manner. Here, the support member 10 is designed e.g. as support plate in a suitable shape lying, in its default position shown in FIG. 1, in contact with a seat plate 17 of the seat cushion 4. Placed on top of the seat plate 17 and the support member 10 is a cushion element not shown here.

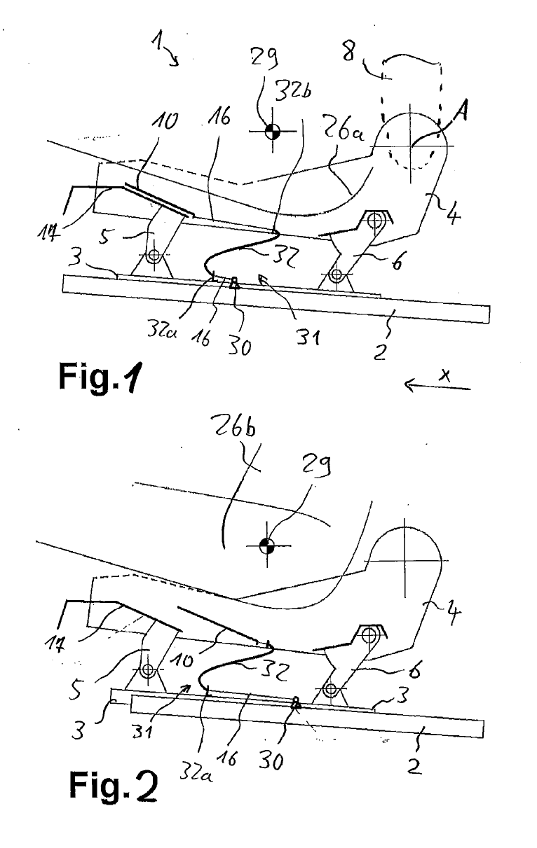

In the embodiment of FIGS. 1, 2 the support member 10 is adjusted depending on the longitudinal position of the upper rail 3 and the seat cushion 4 in relation to the lower rail 2. An arrangement consisting of a wire attachment 30 at the lower rail 2 (or the vehicle chassis) and a Bowden wire 31, comprising a Bowden cable envelope 32 and a wire rope 16, serves as adjustment device. The wire rope 16 is attached at one end to the wire attachment 30 and at its other end directly or indirectly to the support member 10; it severs as coupling device. The Bowden cable envelope 32 is attached at one end 32a to the upper rail 3 and at its other end 32b to the seat cushion 4; thus, it is completely adjusted together with the upper rail 3 in the longitudinal direction; in principle, the wire rope 16 may also be guided e.g. via rolls.

In FIG. 1 a person 26a of normal size, in particular within a normal range of about 95 percent of adult people, is present in the vehicle seat 1, i.e. he sits on the seat cushion 4 and leans against the back rest 8; hereby, he is secured by way of, i.e., by way of, a safety belt, whereby the vertical position of the belt attachment 29 is indicated. The upper rail 3 together with the seat cushion 4 is disposed in a back region of the longitudinal adjustment, with a variable position within that region. The support member 10 is disposed in its default position in which it serves as protection against sliding beneath the seat belt, i.e. as counter surface, for the person 26a, in order to block a forward sliding movement.

In FIG. 2 a person 26b of smaller size sits in the vehicle seat 1. He has adjusted the vehicle seat 1 to a forward position, i.e. upper rail 3 and seat cushion 4 are shifted forward in relation to the lower rail 2. Hereby, the wire rope 16 is tightened pulling the support member 10 in the seat cushion 4 from the seat plate 17 backwards to its activated position, i.e. towards the person 26b or, respectively, towards torso region of the person 26b. Hereby, the adjustment may be backwards and upwards or only upwards. Thus, in the activated position the support member 10 serving as counter surface is closer to the torso region of the person 26b of smaller size and prevents this from sliding beneath the safety belt in the event of a front crash.

Hereby, a continuous adjustment of the support member 10 may be provided; alternatively, there may be no adjustment in a first, back adjustment are, with adjustment happening only in a second, front are, e.g. in a front third. To that end a follower system may be provided in the wire rope 16 or the wire attachment 30.

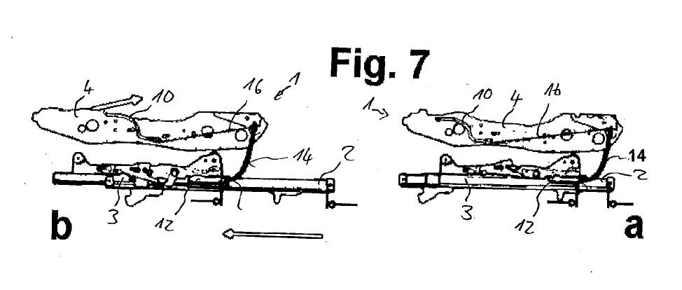

FIG. 7 shows an alternative embodiment, in which a pneumatic, hydraulic or electro-mechanical adjustment device 12 is provided to adjust the support member 10. The adjustment device 12 may be a fluid pump, a compressor or an electric motor. Thus, an adjustment movement of the support member 10 can be adjusted freely, not being limited by the shifting range of the upper rail 3. The adjustment device 12 may serve to adjust only the support member 10; alternatively, the adjustment device 12 may also longitudinally adjust both the support member 10 and the upper rail 3 with the seat cushion 4. Thus, the adjustment device 12 may be disposed on the upper rail 3 or lower rail 2 enabling the adjustment of the support member 10 in the seat cushion 4 via a coupling device 14 connected to the seat cushion 4, e.g., a fluid pipe (hydraulic or pneumatic pressurising pipe) or a wire rope.

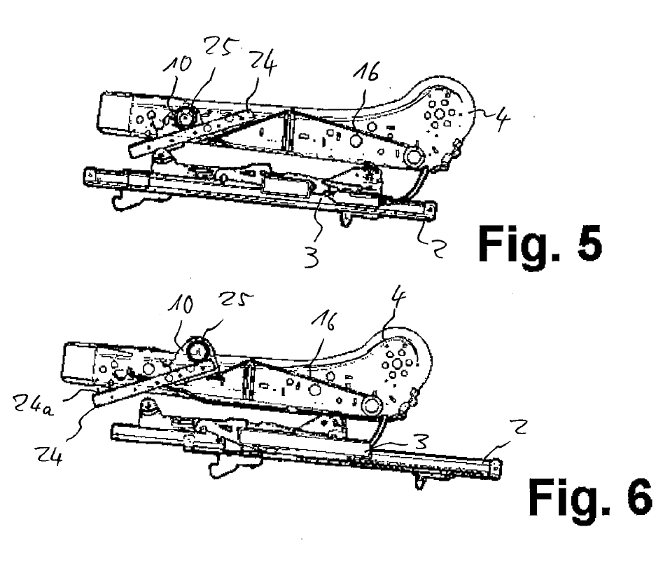

FIG. 5, 6 shows a mechanical adjustment via a wire rope 16 which guides the support member 10 on a ramp 24 provided in the seat cushion, the ramp extending from the front and bottom towards the back and upwards. The ramp 24 may be provided with a gear rod 24a on which a gear wheel 25 of the support member 10 runs; alternatively, embodiments in the form of sliding carriages are possible. Instead of a linear guide, e.g. curved guides are possible.

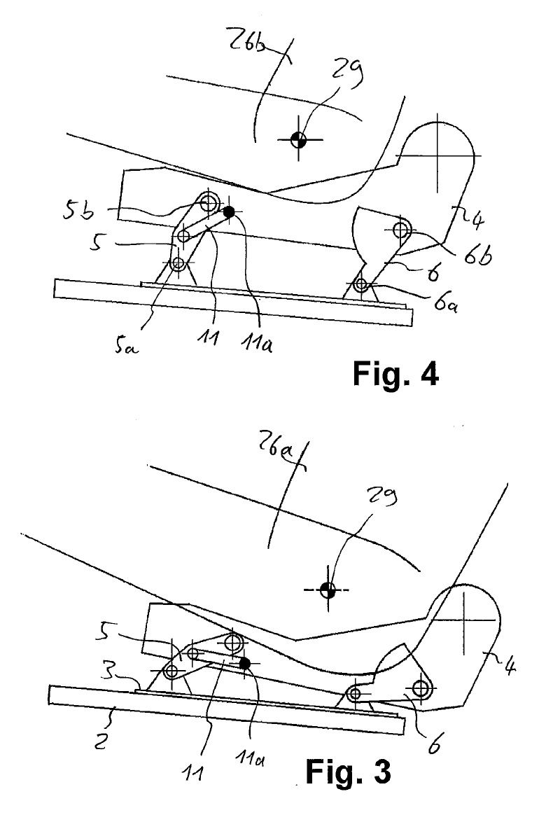

Complementary or alternatively to an adjustment of the support member 10 depending on the longitudinal position of the upper rails 3 with the seat cushion 4 in relation to the lower rails 2, an adjustment depending on the vertical position of the seat cushion 4 in relation to the upper rails 3 is possible, as shown in FIGS. 3, 4.

The seat cushion 4 is coupled, via two front rockers 5 and two back rockers 6, vertically adjustably to the upper rail 3 or even directly to the vehicle chassis; here, the left rockers 5, 6 are shown. Thus, in a known manner, the joints 5a, 6a, 5b, 6b form a parallelogram; however, the embodiment is also conceivable with other types of four bar linkages for seat adjustment. In a central region of the two rockers 5, i.e. between their joints 5a, 5b, a curved tube is firmly attached, e.g. welded, as a support element 11 extending in perpendicular direction y between the two rockers 5 and thereby through the seat cushion 4. Hereby, the support element 11 is bent in a U shape and extends in a central region with a part 11a, whose relative position in the seat cushion 4 therefore changes depending on the pivoting position of the front rockers 5. In the default position of FIG. 3 for a person 26a or normal size it is lowered; in the activated position of FIG. 4 with the seat cushion 4 raised it is adjusted upwards in the seat cushion 4 serving as counter surface, i.e. anti-submarining protection for the person 26b of smaller size.

While this invention has been described as having a preferred design, it is understood that it is capable of further modifications, and uses and/or adaptations of the invention and following in general the principle of the invention and including such departures from the present disclosure as comes within the known or customary practice in the art to which the invention pertains, and as may be applied to the central features hereinbefore set forth, and fall within the scope of the invention.

What is claimed is:

1. Vehicle seat, comprising:
a) a seat cushion to accommodate a person;
b) a support member protecting a person accommodated on the seat cushion against sliding beneath a seat belt;
c) an adjustment device for adjusting the support member relative to the seat cushion;
d) the adjustment device being adapted to adjust the support member between a default position and an activated position depending on a position of the seat cushion relative to another component.

2. Vehicle seat according to claim 1, wherein:
a) at least one lower rail is provided to be attached inside the vehicle and an upper rail longitudinally adjustable accommodated on the lower rail and accommodating the seat cushion, the support member being adjustably accommodated on the seat cushion and the support member being adjustable depending on the longitudinal position of the seat cushion and the upper rail relative to the lower rail, the support member being in the activated position when in a forward longitudinal position of the seat cushion.

3. Vehicle seat according to claim 1, wherein:
a) the support member is adjustable depending on a vertical position of the seat cushion relative to the upper rail or a lower attachment, the support member being adjusted to its activated position when in an upper vertical position of the seat cushion.

4. Vehicle seat according to claim 3, wherein:
a) between the seat cushion and the upper rail or the lower attachment rockers are hinged and the support member can be adjusted by use of at least one rocker.

5. Vehicle seat according to claim 4, wherein:
a) the support member is rigidly attached to two opposite rockers, in particular the two front rockers.

6. Vehicle seat according to claim 5, wherein:
a) the support member extends upwards in a central region, in relation to the perpendicular direction, between the two rockers, e.g. as a curved or cranked tube.

7. Vehicle seat according to claim 1, wherein:
a) the support member assumes further activated positions as intermediate positions between the default position and a fully activated position depending of a position of the seat cushion.

8. Vehicle seat according to claim 1, wherein:
a) the support member is in its default position in a first adjustment range of the seat cushion and adjusted to an activated position in a following adjustment range, in particular a forward range of the longitudinal adjustment and/or upper range of the vertical adjustment.

9. Vehicle seat according to claim 1, wherein:
a) at least one upper rail and lower rail is provided; and
b) the adjusting device is provided on the at least one upper rail and the lower rail, and a coupling device is provided between the adjusting device and a supporting part on the seat cushion.

10. Vehicle seat according to claim 9, wherein:
a) the coupling device is a mechanical coupling device, in particular a wire rope, via which the adjustment device actuates the support member.

11. Vehicle seat according to claim 10, wherein:
a) the wire rope is provided between the support device and an attachment provided on the lower rail for adjusting the support member depending on the longitudinal position of the upper rail and the seat cushion in relation to the lower rail.

12. Vehicle seat according to claim 11, wherein:
a) a Bowden wire envelope is attached to the seat cushion and the upper rail for guiding the wire rope.

13. Vehicle seat according to 9, wherein:
a) a fluid pipe for guiding a fluid, in particular a hydraulic fluid or pressurised air, is provided as coupling device; and
b) a compressor or a hydraulic pump is provided in or on the upper rail as the adjustment device.

14. Vehicle seat according to claim 2, wherein:
a) the adjustment device is provided to also longitudinally adjust the upper rail in relation to the lower rail and/or to also vertically adjust the seat cushion.

15. Vehicle seat according to claim 1, wherein:
a) in or on the seat cushion a support element guide element, e.g. a ramp, is provided for guiding the support member from the lowered default position to the upper activate position of the support member.

16. Vehicle seat according to claim 15, wherein:
a) the support element guide element is designed as an inclined ramp and the guide element slides or rolls on the ramp, the ramp extending in the seat cushion from the front bottom towards the back and upwards.
